(19) United States
(12) Patent Application Publication
(10) Pub. No.: US 2008/0018251 A1
(43) Pub. Date: Jan. 24, 2008

(54) Plasma display panel

(76) Inventors: Kyoung-Doo Kang, Suwon-si (KR); Won-Ju Yi, Suwon-si (KR); Ho-Young Ahn, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/827,702

(22) Filed: Jul. 13, 2007

(30) Foreign Application Priority Data
Jul. 18, 2006 (KR) 10-2006-0067048

(51) Int. Cl. H01J 17/49

(52) U.S. Cl. 313/586

(57) ABSTRACT

Provided is a plasma display panel. The plasma display panel includes a plurality of substrates comprising a first substrate realizing an image and a second substrate, dielectric walls disposed between the first substrate and the second substrate and defining a plurality of discharge cells, a plurality of a pair of discharge electrodes buried in the dielectric walls and generating a discharge using power that is applied, and phosphor layers formed on the dielectric walls between the discharge electrodes. Luminance and light emitting efficiency of the plasma display panel increase since the distance between the discharge electrodes and the phosphor layers is close by covering the pair of discharge electrodes inside the dielectric walls defining the discharge cells with the plurality of substrates and forming the phosphor layers on the dielectric walls between the discharge electrodes.

### CROSS-REFERENCE TO RELATED PATENT APPLICATION

This application claims the benefit of Korean Patent Application No. 10-2006-0067048, filed on Jul. 18, 2006, in the Korean Intellectual Property Office, the disclosure of which is incorporated herein in its entirety by reference.

### BACKGROUND OF THE INVENTION

1. Field of the Invention

The present embodiments relate to a plasma display panel, and more particularly, to a plasma display panel that has an improved discharge efficiency by disposing phosphor layers on dielectric walls defining discharge cells with substrates.

2. Description of the Related Art

In general, plasma display panels (PDPs) are flat panel display devices in which a discharge gas is injected between a pair of substrates including a plurality of discharge electrodes that generate a discharge, and phosphor layers are excited by ultraviolet rays generated due to the discharge of the plurality of discharge electrodes in order to display desired numbers, characters, and images.

Such PDPs can be classified into a direct current (DC) type and an alternating current (AC) type according to patterns of waveforms of driving voltages applied to discharge cells, for example, according to the form of the discharge of the plurality of discharge electrodes. Such PDPs can also be classified into an opposed discharge type and a surface discharge type according to the arrangement of the discharge electrodes.

FIG. 1 is a partially exploded perspective view of a conventional three-electrode surface discharge plasma display panel 100.

As illustrated in FIG. 1, the conventional three-electrode surface discharge plasma display panel (PDP) 100 includes a first substrate 101, a second substrate 102, an X electrode 104 and a Y electrode 105 constituting a pair of sustain discharge electrodes 103 disposed on an inner surface of the first substrate 101, a first dielectric layer 106 covering the pair of sustain discharge electrodes 103, a protective layer 107 coated on a lower surface of the first dielectric layer 106, an address electrode 108 formed on an upper surface of the second substrate 102 and disposed intersecting the pair of sustain discharge electrodes 103, a second dielectric layer 109 covering the address electrode 108, barrier ribs 110 disposed between the first and second substrates 101 and 102, and phosphor layers 111 for red, green, and blue colors formed inside a discharge cell defined by the barrier ribs 110. A discharge gas is injected into an inner space between the first and second substrates 101 and 102 to form a discharge area.

In the conventional three-electrode surface discharge plasma display panel 100 including the above structure, an electric signal is applied to the Y electrode 105 and the address electrode 108 to select a discharge cell, an electric signal is applied alternately to the X and Y electrodes 104 and 105 to generate a surface discharge from the inner surface of the first substrate 101 and to generate ultraviolet rays such that visible light is emitted from the phosphor layer 111 in the selected discharge cell to display a stopped image or moving picture.

However, the conventional three-electrode surface discharge plasma display panel 100 includes the following problems.

First, the transmittance of light emitted from a discharge cell is less than 60% due to not only the pair of sustain discharge electrodes 103, but also the first dielectric layer 106 and the protective layer 107 that are formed on an inner surface of the first substrate 101. Therefore, a high efficiency flat panel display device cannot be realized.

Second, when the conventional three-electrode surface discharge plasma display panel 100 is operated for a prolonged period of time, a permanent latent image occurs due to ion sputtering of charged particles of a discharge gas onto the phosphor layer 111 due to an electric field produced when the discharge gas diffuses towards the phosphor layer 111.

Third, a discharge gas diffuses from a discharge gap between the X and Y electrodes 104 and 105 towards the outside. The discharge gas diffuses along the surface of the first substrate 101, and thus the space efficiency of the discharge cells is low.

Fourth, when a discharge gas containing a high concentration of Xe gas, for example, 10 vol % or more, is filled in the discharge cells, extra plasma is produced. The extra plasma increases ionization of atoms and an excitation reaction, thus, extra charged particles and excitations occur. Accordingly, the brightness and discharge efficiency of a device can be high. However, the high concentration of Xe gas results in a high initial discharge voltage.

Fifth, the first and second substrates 101 and 102 are formed of a transparent substrate, for example, glass such as soda lime glass or PD-200. In this case, the first and substrates 101 and 102 are heavy due to the increased thicknesses of the first and substrates 101 and 102. Accordingly, the weight of the conventional three-electrode surface discharge plasma display panel 100 increases.

### SUMMARY OF THE INVENTION

The present embodiments provide a plasma display panel that has improved luminance and discharge efficiency by covering a discharge electrode inside dielectric walls defining a discharge cell with a plurality of substrates and forming a phosphor layer on the dielectric walls between the discharge electrodes.

According to an aspect of the present embodiments, there is provided a plasma display panel, including: a plurality of substrates comprising a first substrate realizing an image and a second substrate; dielectric walls disposed between the first substrate and the second substrate and defining a plurality of discharge cells; a plurality of a pair of discharge electrodes buried in the dielectric walls and generating a discharge using power that is applied; and phosphor layers formed on the dielectric walls between the discharge electrodes.

The phosphor layers may be formed on a front surface of the dielectric walls corresponding to a space between the discharge electrodes that are separated and not formed on the same surface.

The phosphor layers may be formed along an inner circumference of the discharge cell.

The dielectric walls may be formed of a plurality of dielectric sheets and the phosphor layers may be formed on a front surface of any one of the dielectric sheets defining a discharge cell.

The dielectric walls may include a first dielectric sheet and a second dielectric sheet such that each of the first and second dielectric sheets cover the pair of discharge electrodes which are separated and not formed on the same surface; and a third dielectric sheet disposed between the first and second dielectric sheets.

The phosphor layers may be formed on a front surface of the third dielectric sheet.

The dielectric walls may include a space between the pair of electrodes which are separated and not formed on the same surface, and the phosphor layers are formed inside the space.

Insert grooves may be formed in the dielectric walls between the discharge electrodes that are separated and not formed on the same surface and the phosphor layers are formed in the insert grooves.

### BRIEF DESCRIPTION OF THE DRAWINGS

The above and other features and advantages of the present embodiments will become more apparent by describing in detail exemplary embodiments thereof with reference to the attached drawings in which:

FIG. 1 illustrates a partially exploded perspective view of a conventional three-electrode surface discharge plasma display panel;

FIG. 2 illustrates a partially exploded perspective view of a plasma display panel according to an embodiment;

FIG. 3 illustrates a cross-sectional view taken along line I-I of the plasma display panel illustrated in FIG. 2;

FIG. 4 illustrates a perspective view of a discharge electrode of the plasma display panel illustrated in FIG. 2;

FIG. 5 illustrates a cross-sectional view of a plasma display panel according to another embodiment;

FIG. 6 illustrates a cross-sectional view of a plasma display panel according to another embodiment;

FIG. 7 illustrates a cross-sectional view of a plasma display panel according to another embodiment;

FIG. 8 illustrates a cross-sectional view of a plasma display panel according to another embodiment;

FIG. 9 illustrates a cross-sectional view of a plasma display panel according to another embodiment.

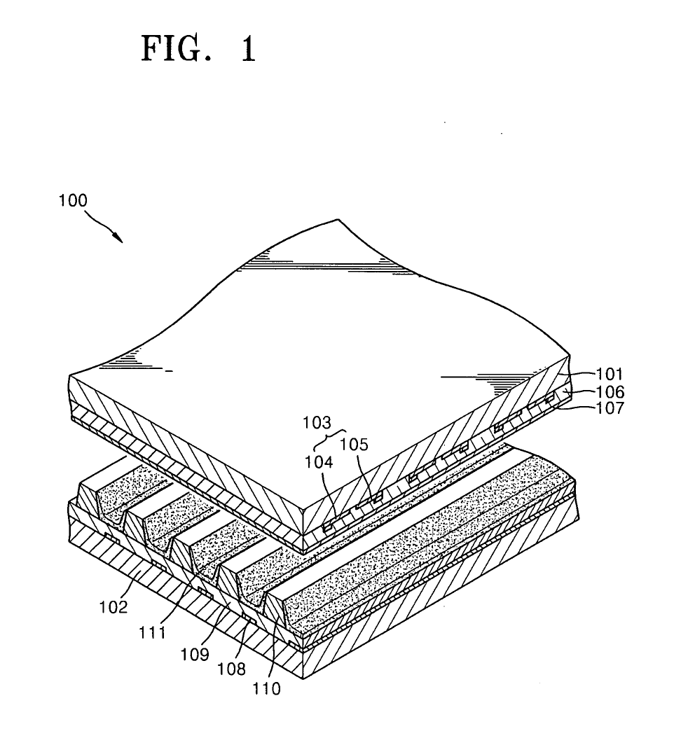

### DETAILED DESCRIPTION OF THE INVENTION

Hereinafter, the present embodiments will be described more fully with reference to the accompanying drawings, in which exemplary embodiments are shown.

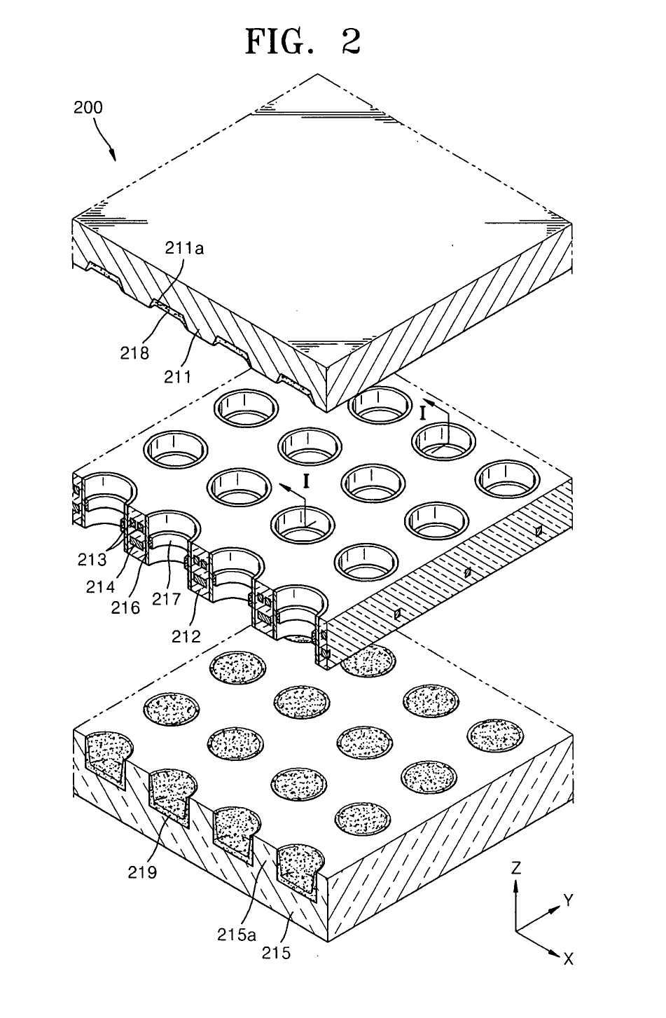

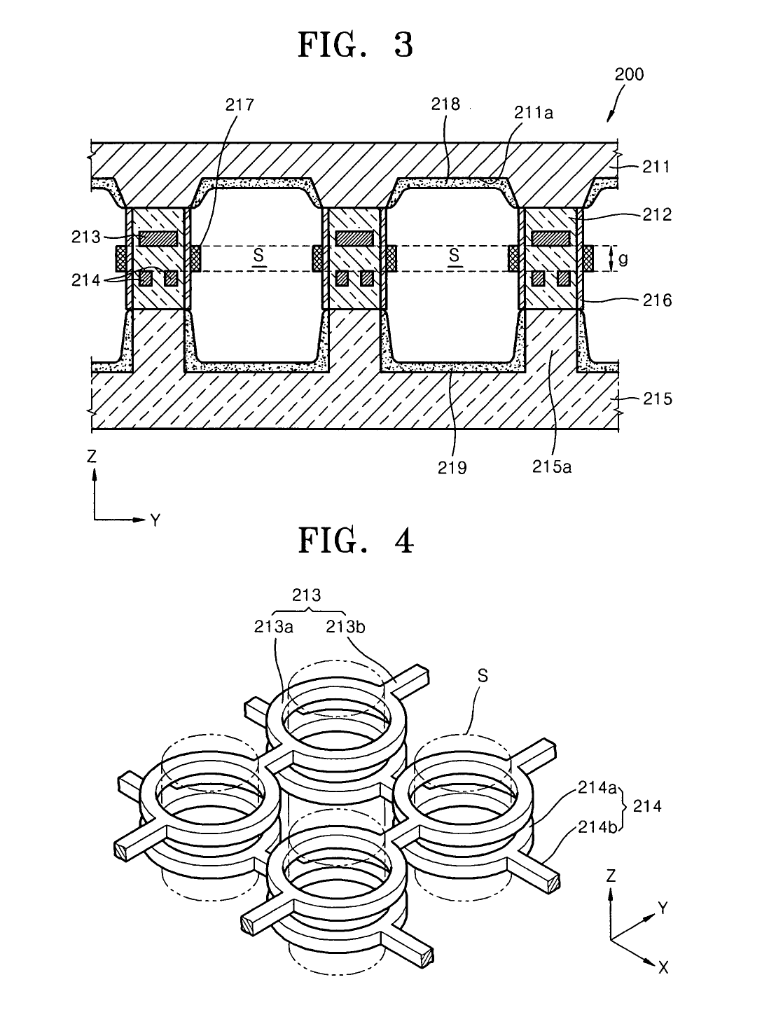

FIG. 2 illustrates a partially exploded perspective view of a plasma display panel 200 according to an embodiment, FIG. 3 illustrates a cross-sectional view taken along line I-I of the plasma display panel 200 illustrated in FIG. 2, and FIG. 4 illustrates a perspective view of a discharge electrode of the plasma display panel 200 illustrated in FIG. 2.

Referring to FIGS. 2 through 4, the plasma display panel 200 includes a first substrate 211. The first substrate 211 is formed of a material which has excellent optical permeability, such as glass. Also, the first substrate 211 may be colored or semitransparent to improve bright room contrast by reducing a reflecting luminance.

Dielectric walls 212 are formed below the first substrate 211 to define discharge cells S and to prevent electrical and optical crosstalk between the adjacent discharge cells S. A plurality of a pair of first and second discharge electrodes 213 and 214 are buried in the dielectric walls 212.

The dielectric walls 212 may be formed of a high dielectric material that can prevent electric connection between the first discharge electrodes 213 and the second discharge electrodes 214, can prevent damages to the first and second discharge electrodes 213 and 214 due to a cation or an electron, and can accumulate wall charges by inducing electric charges.

In the current embodiment, the dielectric walls 212 are formed to define the discharge cells S having circular transverse sections, but the current embodiment is not limited thereto. That is, the dielectric walls 212 may be formed to define the discharge cells S to various patterns such as polygonal transverse sections, circular transverse sections, or non-circular transverse sections, as long as the dielectric walls 212 define the discharge cells S. Alternatively, the dielectric walls 212 can be formed to define delta type discharge cells S, waffle type discharge cells, or meander type discharge cells.

The first discharge electrodes 213 extend around the circumference of the discharge cells S disposed along a Y direction of the plasma display panel 200. The first discharge electrodes 213 are formed of first loops 213a surrounding the circumference of the discharge cells S in an open loop or a closed loop and first bridges 213b electrically connecting the adjacent first loops 213a.

In the current embodiment, the first loops 213a are in a circular closed loop, but the current embodiment is not limited thereto, and can be in various forms, such as a square or hexagon open loop or closed loop. But preferably, the first loops 213a may substantially have the same form as the transverse section of the discharge cells S.

The second discharge electrodes 214 extend while surrounding the circumference of the discharge cells S disposed along a X direction of the plasma display panel 200, that is, extend in a direction intersecting the first discharge electrodes 213. The second discharge electrodes 214 are spaced apart from the first discharge electrodes 213 in the dielectric walls 212 in a Z direction of the plasma display panel 200, that is, spaced apart in a direction perpendicular to the first substrate 211.

Here, the second discharge electrodes 214 include the second loops 214a such that each of the second loops 214a surround the discharge cells S and are electrically connected by the second bridges 214b.

In the current embodiment, the second loops 214a are in a circular closed loop, but the second loops 214a are not limited thereto, and can be in various forms such as a square open loop or closed loop, or the like. But preferably, the second loops 214a may have substantially the same form as the transverse section of the discharge cells S of the plasma display panel 200.

Since the first and second discharge electrodes 213 and 214 are not disposed on locations that directly reduce the visible light transmission rate such as an inner surface of the first substrate 211, the first and second discharge electrodes 213 and 214 may be formed of a metal having an excellent conductivity, such as aluminum, copper, or the like.

The plasma display panel 200 has a two-electrodes structure formed of the first and second discharge electrodes 213 and 214. Either one of the first and second discharge electrodes 213 and 214 functions as a scanning and sustain electrode, while the other one functions as an address and sustain electrode.

Protective layers 216 may be formed along the sidewalls of the dielectric walls 212. The protective layers 216 prevent damage to the dielectric walls 212 and the first and second discharge electrodes 213 and 214 caused by sputtering of plasma particles and at the same time, reduce a discharge voltage by emitting secondary electrons. The protective layer 216 may be formed of, for example, magnesium oxide (MgO).

A second substrate 215 is disposed below the dielectric walls 212. The first substrate 211, the second substrate 215 are combined with the dielectric walls 212 that are disposed between the first and second substrates 211 and 215 in order to seal up discharge gas injected inside the discharge cells S.

The second substrate 214 can be prepared while preparing the dielectric walls 212 by using the same plastic process in order to prepare the second substrate 214 and the dielectric walls 212 integrally. Alternatively, the dielectric walls 212 may be prepared using a different plastic process, and then the second substrate 214 and the dielectric walls 212 are combined during a sealing process.

Also, inside the discharge cells S, the discharge gas, such as neon (Ne), xenon (XE), etc., or mixture thereof, is sealed. According to the current embodiment, a discharge surface and discharge area can increase and thus, increasing the amount of plasma utilized. Accordingly, the plasma display panel 200 can operate using a low voltage. Thus, even when highly concentrated Xe is used as discharge gas, operation of the plasma display panel 200 using a low voltage is possible, thereby remarkably increasing light emitting efficiency.

In the current embodiment, first phosphor layers 217, which generate visible light using ultraviolet rays, are formed along the dielectric walls 212 that are between the first and second discharge electrodes 213 and 214.

That is, each one of the first discharge electrodes 213 and the second discharge electrodes 214 are disposed on one discharge cell S and spaced apart from each other by a predetermined space in a perpendicular direction to the plasma display panel 200. Accordingly, the first and second discharge electrodes 213 and 214 are not disposed on the same surface, and the first discharge electrodes 213 are disposed relatively adjacent to the first substrate 211 while the second discharge electrodes 214 are disposed relatively adjacent to the second substrate 215.

Spaces g are possible in the Z direction, which is a direction perpendicular to the plasma display panel 200, corresponding to a distance between the first and second discharge electrodes 213 and 214. On a front surface of the dielectric walls 212 corresponding to the spaces g, first phosphor layers 217 are formed.

The first phosphor layers 217 may be formed on the front surface of the dielectric walls 212 along an inner circumference of the discharge cells S in the same direction that the first and second discharge electrodes 213 and 214 are formed. The first phosphor layers 217 can be formed using various methods, such as an ink jet method, a dispensing method, a deposition method, etc.

According to the current embodiment, protective layers 216 are further formed between the dielectric walls 212 and the first phosphor layers 217. However, from among the surfaces of the dielectric walls 212, the protective layers 216 are preferably not formed on areas where the first phosphor layers 217 are to be formed.

The first phosphor layers 217 include a component that generates visible light using ultraviolet rays. The first phosphor layers 217 formed on red light emitting discharge cells S include a fluorescent substance such as Y(V,P)O₄:Eu, or the like, the first phosphor layers 217 formed on green light emitting discharge cells S include a fluorescent substance such as Zn₂SiO₄:Mn, YBO₃:Tb, or the like, and the first phosphor layers 217 formed on blue light emitting discharge cells S include a fluorescent substance such as BAM:Eu, or the like.

Also, grooves 211a, of a predetermined depth, are formed in an inner surface of the first substrate 211 corresponding to each of the discharge cells S. The grooves 211a are formed independently from each of the discharge cells S and substantially have the same form as the discharge cells S. Second phosphor layers 218 are formed in the grooves 211a. The second phosphor layers 218 are substantially formed of the same material as the first phosphor layers 217.

Barrier ribs 215a are formed on the second substrate 215. The barrier ribs 215a are formed on areas corresponding to the dielectric walls 212 in the same form as the dielectric walls 212. The barrier ribs 215a are formed by processing the second substrate 215, such that the barrier ribs 215a and the second substrate 215 are integrally formed.

Alternatively, the barrier ribs 215a may be formed on a surface of the second substrate 215 using a different material than the second substrate 215, but the embodiments are not limited thereto. Third phosphor layers 219 are formed in discharge spaces formed by the barrier ribs 215a. The third phosphor layers 219 and the first phosphor layers 217 are substantially formed of the same material.

When luminance and discharge efficiency of the plasma display panel 200 are excellent, the second phosphor layers 218 that are formed on the first substrate 211 and the third phosphor layers 219 that are formed on the second substrate 215 may optionally be excluded.

Hereinafter, the operation of the plasma display panel 200 will be described.

First, an addressing discharge is generated between the first discharge electrode 213 and the second discharge electrode 214. As a result of the addressing discharge, a discharge cell S, which is to generate a sustain discharge, is selected. Then, when a sustain discharge voltage is applied between the first and second discharge electrodes 213 and 214 of the selected discharge cell S, the sustain discharge is generated between the first and second discharge electrodes 213 and 214.

As the energy level of the excited discharge gas decreases due to the generated sustain discharge, ultraviolet rays are radiated. The radiated ultraviolet rays excite the first, second, and third phosphor layers 217, 218, and 219 at the same time. As the energy levels of the excited first, second, and third phosphor layers 217, 218, and 219 decreases, visible light is emitted. Accordingly, the emitted visible light realizes an image.

As described, according to the plasma display panel 200, visible light efficiency can be increased since the first, second, and third phosphor layers 217, 218, and 219 are simultaneously formed on the first substrate 211, the second substrate 215, and barrier ribs 212, respectively.

FIG. 9 illustrates a cross-sectional view of a plasma display panel 900 according to another embodiment.

Referring to FIG. 9, the plasma display panel 900 includes a first substrate 911, a second substrate 915 disposed facing the first substrate 911, and dielectric walls 912 disposed between the first and second substrates 911 and 915.

Grooves 911a are formed on an inner surface of the first substrate 911 corresponding to discharge cells S. Barrier ribs 915a are integrally formed with the second substrate 915 and integrally protrude from the second substrate 915.

In the present embodiment, the dielectric walls 912 are formed of first dielectric sheets 912a in which first discharge electrodes 913 are disposed, second dielectric sheets 912b in which second discharge electrodes 914 are disposed, and third dielectric sheets 912c disposed between the first and second dielectric sheets 912a and 912b. The first, second, and third dielectric sheets 912a, 912b, and 912c are stacked in a perpendicular direction to the plasma display panel 900 to form the dielectric walls 912.

Protective layers 916 are formed on an outer surface of the first dielectric sheets 912a and on an outer surface of the second dielectric sheets 912b. The protective layers 916 may not be formed on an outer surface of the third dielectric sheets 912c.

First phosphor layers 917 are formed on a front surface of the third dielectric sheets 912c. Also, second phosphor layers 918 are formed in a plurality of grooves 911a that are formed in an inner surface of the first substrate 911, and third phosphor layers 919 are formed in an inner side of the barrier ribs 915a.

The first phosphor layers 917 are formed on a side wall of the third dielectric sheets 912c to connect the discharge cells S through an ink jet method or a deposition method, wherein the discharge cells S are formed by punching using a film.

The second phosphor layers 918 may directly be formed on an inner surface of the first substrate 911 without forming the grooves 911a. The barrier ribs 915a may be prepared separately from the second substrate 915.

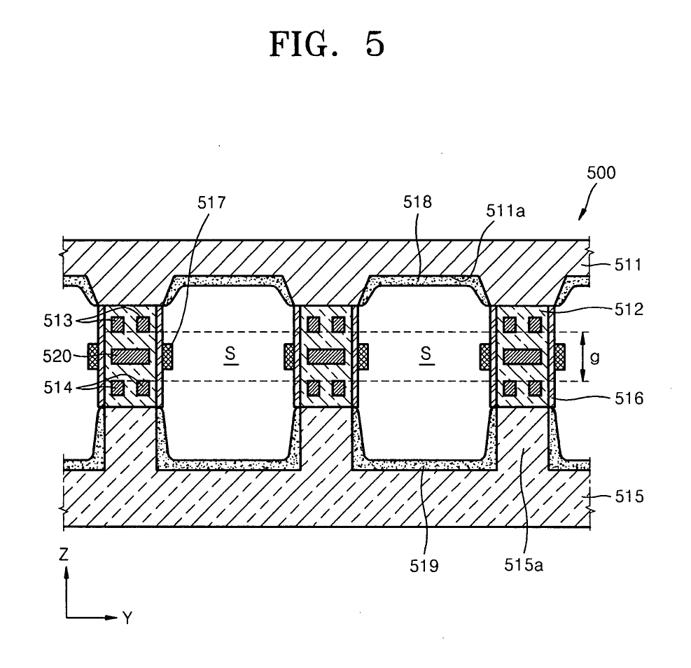

FIG. 5 illustrates a cross-sectional view of a plasma display panel 500 according to another embodiment.

Referring to FIG. 5, the plasma display panel 500 includes a first substrate 511, a second substrate 515 disposed facing the first substrate 511, and dielectric walls 512 disposed between the first and second substrates 511 and 515.

Grooves 511a, corresponding to each of the discharge cells S, are formed in an inner surface of the first substrate 511, and protruding barrier ribs 515a are formed on the second substrate 515.

First, second, and third discharge electrodes 513, 514, and 520 are formed inside the dielectric walls 512 in a perpendicular direction to the plasma display panel 500. The first discharge electrodes 513 are disposed relatively adjacent to the first substrate 511 as compared to the second and third discharge electrodes 514 and 520, the second discharge electrodes 514 are disposed relatively adjacent to the second substrate 515 as compared to the first and third discharge electrodes 513 and 520, and the third discharge electrodes 520 are disposed between the first and second discharge electrodes 513 and 514.

The first discharge electrodes 513 and the second discharge electrodes 514 correspond to X electrodes and Y electrodes, respectively, and pair up in each of the discharge cells S to generate a sustain discharge. The first and second discharge electrodes 513 and 514 extend in parallel to each other. Also, the third discharge electrodes 520 extend in a crossing direction to the extending direction of the first and second discharge electrodes 513 and 514. The third discharge electrodes 520 correspond to address electrodes generating an addressing discharge with the second discharge electrodes 514.

In the current embodiment, the first discharge electrodes 513, the third discharge electrodes 520, and the second discharge electrodes 514 are sequentially disposed in a perpendicular direction to the plasma display panel 500, but the sequence of disposing the discharge electrodes is not limited thereto.

The third discharge electrodes 520, to which an addressing voltage is applied, may be disposed relatively adjacent to the first substrate 511 as compared to the first and second discharge electrodes 513 and 514, or may be disposed inside the second substrate 515.

Protective layers 516, such as magnesium oxide, may be formed on an inner surface of the dielectric walls 512.

The dielectric walls 512 include spaces g corresponding to a distance between the first and second discharge electrodes 513 and 514 that are wide enough to bury the third discharge electrodes 520, which generate a sustain discharge, and where first phosphor layers 517 are formed on the corresponding front surface of the dielectric walls 514.

Also, second phosphor layers 518 are formed in the plurality of grooves 511a that are formed in an inner surface of the first substrate 511. Third phosphor layers 519 are formed on an inner side of the barrier ribs 515a defining the discharge cells S.

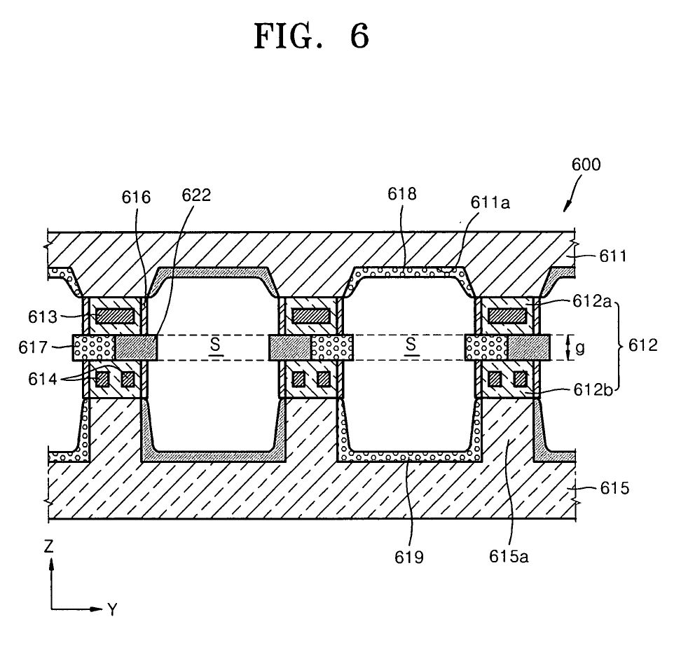

FIG. 6 illustrates a cross-sectional view of a plasma display panel 600 according to another embodiment.

Referring to FIG. 6, the plasma display panel 600 includes a first substrate 611, a second substrate 615 disposed facing the first substrate 611, and dielectric walls 612 disposed between the first and second substrates 611 and 615 and defining discharge cells S with the first and second substrates 611 and 615. The dielectric walls 612, as the dielectric walls 912 illustrated in FIG. 9, are formed of dielectric sheets. Protective layers 616 are formed on a surface of the dielectric walls 612.

First discharge electrodes 613 and second discharge electrodes 614 are buried in the dielectric walls 612, and disposed separately in a perpendicular direction to the plasma display panel 600. Spaces g are generated between the first and second discharge electrodes 613 and 614. Accordingly, the dielectric walls 612 are divided into first dielectric walls 612a, which are formed in sheet forms, and second dielectric walls 612b, which are formed in sheet forms, on both sides of the spaces g.

First phosphor layers 617 are formed in the spaces g. The first phosphor layers 617, based on one discharge cell S, are formed to fill ½ of the spaces g in a thickness direction of the dielectric walls 612. The remaining half of the spaces g is filled with formed first phosphor layers 622 in different colors in order to contribute in terms of luminance of an adjacent discharge cell S.

That is, the first phosphor layers 617 and 622 are formed for each discharge cell S in different colors, the first phosphor layers 617 and 622 in different colors are disposed into ½ of the spaces g in a thickness direction of the dielectric walls 612. Alternatively, the amount of a phosphor layer applied on a discharge cell S having relatively low luminance may be increased.

Also, grooves 611a are formed on areas in an inner surface of the first substrate 611 corresponding to each discharge cell S and second phosphor layers 618 are formed in the grooves 611a.

Barrier ribs 615a are formed on the second substrate 615. The barrier ribs 615a may be formed on the upper second substrate 615 using a different material than the second substrate 615, but it is advantageous to form the barrier ribs 615a integrally as one unit with the second substrate 615 by processing the second substrate 615. Third phosphor layers 619 are formed in discharge spaces formed by the forming of the barrier ribs 615a.

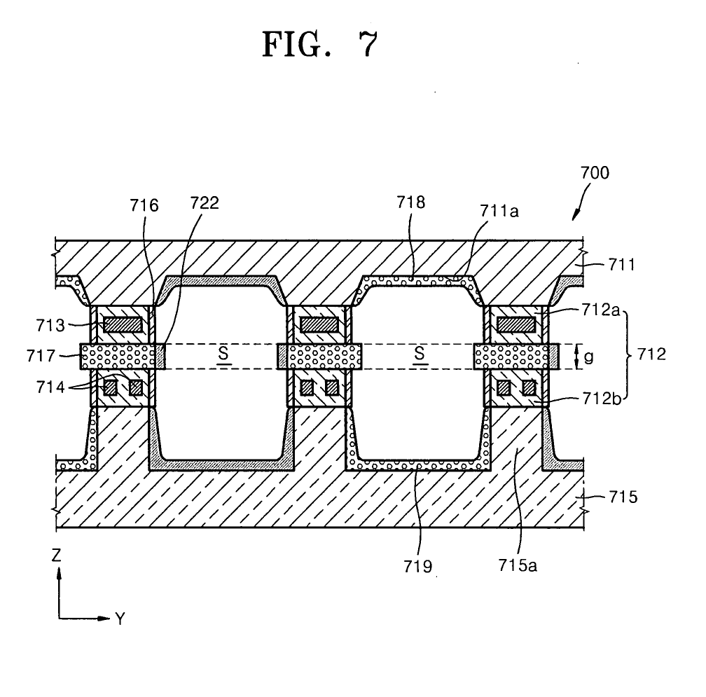

FIG. 7 is a cross-sectional view of a plasma display panel 700, according to another embodiment.

Referring to FIG. 7, the plasma display panel 700 includes a first substrate 711, a second substrate 715 disposed facing the first substrate 711, and dielectric walls 712 disposed between the first and second substrates 711 and 715 that define discharge cells S with the first and second substrates 711 and 715. Protective layers 716 are formed on a surface of the dielectric walls 712.

The dielectric walls 712 are divided into first dielectric walls 712a, which are formed in sheet forms, and second dielectric walls 712b, which are formed in sheet forms. First discharge electrodes 713 are buried in the first dielectric walls 712a and second discharge electrodes 714 are buried in the second dielectric walls 712b.

Spaces g are formed between the first and second dielectric walls 712a and 712b. First phosphor layers 717 are formed to fill the spaces g. Also, first phosphor layers 722 are formed in different colors on a surface of the first phosphor layers 717 to a predetermined thickness in order to contribute in terms of luminance of another adjacent discharge cell S.

That is, in one discharge cell S, the first phosphor layers 717 fill the spaces g and in another adjacent discharge cell S, the first phosphor layers 722 in different colors are formed on a surface of the first phosphor layers 717, contacting the another adjacent discharge cell S. Amounts of the first phosphor layers 717 and 722 differ, wherein the amount applied on a discharge cell S having relatively low luminance is larger.

Also, grooves 711a are formed on areas in an inner surface of the first substrate 711 corresponding to each unit discharge cell S, and second phosphor layers 718 are formed in each groove 711a.

Barrier ribs 715a are formed on the second substrate 715. The barrier ribs 715a may be formed on the upper second substrate 715 using a different material, but it is advantageous to form the barrier ribs 715a integrally as one unit with the second substrate 715 by processing the second substrate 715. Third phosphor layers 719 are formed in the discharge cells S on an inner side of the barrier ribs 715a.

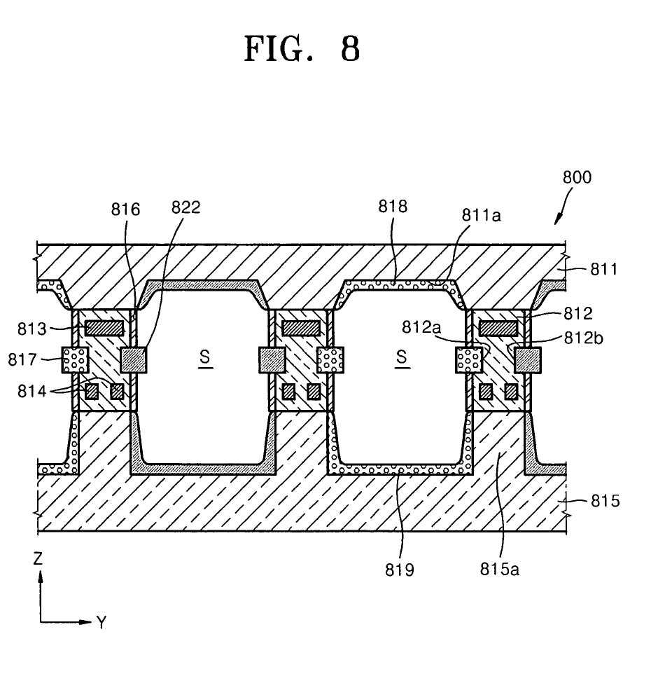

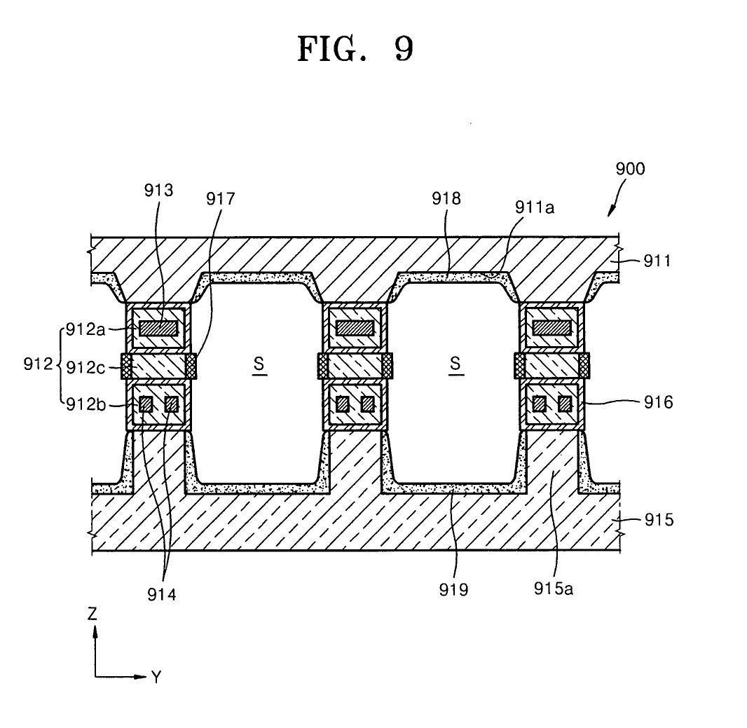

FIG. 8 is a cross-sectional view of a plasma display panel 800 according to another embodiment.

Referring to FIG. 8, the plasma display panel 800 includes a first substrate 811, a second substrate 815 disposed facing the first substrate 811, and dielectric walls 812 disposed between the first and second substrates 811 and 815 and defining the discharge cells S. It is advantageous to form the dielectric walls 812 in dielectric sheets.

First discharge electrodes 813 and the second discharge electrodes 814 are formed inside the dielectric walls 812. The first and second discharge electrodes 813 and 814 are disposed separately from each other in a perpendicular direction to the plasma display panel 800. Also, protective layers 816 are formed on an inner side surface of the dielectric walls 812.

Spaces are formed between the first and second discharge electrodes 813 and 814. Insert grooves 812a, are formed to a predetermined depth in a sidewall of the dielectric walls 812 in a thickness direction of the dielectric walls 812.

The insert grooves 812a, based on one discharge cell S, are formed within a location where either one of the first and second discharge electrodes 813 and 814, which participate in a discharge of the discharge cell, is disposed. Another adjacent discharge cell S, which corresponds to the other side of the dielectric walls 812, has insert grooves 812b to the same depth as the insert grooves 812a. Accordingly, a cross-sectional view of the dielectric walls 812 is in an “I” shape.

The insert grooves 812a and 812b each include first phosphor layers 817 and 822 in different colors that are used in the discharges of different discharge cells. The current embodiment will be described based on the discharge cells including the first phosphor layers 817.

The first phosphor layers 817 may be formed along an inner circumference of the discharge cells between the first and second discharge electrodes 813 and 814. Also, the grooves 811a are formed on areas in an inner surface of the first substrate 811 that corresponds to each of the discharge cells S. Second phosphor layers 818 are formed inside the grooves 811a. Barrier ribs 815a are formed integrally as one unit with the second substrate 815, and third phosphor layers 819 are formed inside the discharge cells S in an inner side of the barrier ribs 815a.

Luminance and light emitting efficiency of the plasma display panel according to the present embodiments increase since the distance between discharge electrodes and phosphor layers is close by burying the pair of discharge electrodes inside dielectric walls defining discharge cells with a plurality of substrates and forming the phosphor layers on the dielectric walls between the discharge electrodes.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel, comprising:
a first substrate;
a second substrate facing the first substrate;
dielectric walls disposed between the first substrate and the second substrate and defining a plurality of discharge cells;
a plurality of pairs of discharge electrodes buried in the dielectric walls; and
phosphor layers formed on the dielectric walls between the discharge electrodes.

2. The plasma display panel of claim 2, wherein the phosphor layers are formed on a front surface of the dielectric walls corresponding to a space between the discharge electrodes that are separated and not formed on the same surface.

3. The plasma display panel of claim 2, wherein the phosphor layers are formed along an inner circumference of the discharge cell.

4. The plasma display panel of claim 1, wherein the dielectric walls are formed of a plurality of dielectric sheets and the phosphor layers are formed on a front surface of any one of the dielectric sheets defining a discharge cell.

5. The plasma display panel of claim 4, wherein the dielectric walls comprise a first dielectric sheet and a second dielectric sheet such that each of the first and second dielectric sheets cover the pair of discharge electrodes which are separated and not formed on the same surface; and a third dielectric sheet disposed between the first and second dielectric sheets.

6. The plasma display panel of claim 5, wherein the phosphor layers are formed on a front surface of the third dielectric sheet.

7. The plasma display panel of claim 1, wherein the dielectric walls comprise a space between the pair of electrodes which are separated and not formed on the same surface, and wherein the phosphor layers are formed inside the space.

8. The plasma display panel of claim 7, wherein the dielectric walls comprise a first dielectric sheet and a second dielectric sheet, wherein a space is formed between the first and second dielectric sheets.

9. The plasma display panel of claim 8, wherein the phosphor layers of different colors, which contribute in terms of luminance of the adjacent discharge cells, are each formed inside the space formed between the first and second dielectric sheets.

10. The plasma display panel of claim 1, wherein insert grooves are formed in the dielectric walls between the discharge electrodes that are separated and not formed on the same surface and the phosphor layers are formed in the insert grooves.

11. The plasma display panel of claim 10, wherein the insert grooves are formed along the thickness direction of the dielectric walls on both sides to a predetermined depth, and phosphor layers of different colors, which contribute in terms of luminance of adjacent discharge cells, are formed inside the insert grooves.

12. The plasma display panel of claim 1, wherein the pair of discharge electrodes comprises a first discharge electrode and a second discharge electrode intersecting the first discharge electrode.

13. The plasma display panel of claim 1, wherein the pair of discharge electrodes comprises a first discharge electrode, a second discharge electrode extending in the same direction as the first electrode in order to generate a sustain discharge, and a third discharge electrode intersecting the first and second discharge electrodes in order to generate an addressing discharge with the second discharge electrode.

14. The plasma display panel of claim 1, wherein the pair of discharge electrodes extend to different directions while covering the circumferences of the discharge cells.

15. The plasma display panel of claim 1, further comprising a protective layer between the dielectric walls and the phosphor layers.

16. The plasma display panel of claim 15, wherein the protective layer comprises MgO.

17. The plasma display panel of claim 1, wherein grooves of a predetermined depth are formed in spaces on the first substrate corresponding to each discharge cell and further comprising phosphor layers formed inside the grooves.

18. The plasma display panel of claim 1, further comprising phosphor layers formed on surfaces of the first substrate corresponding to each discharge cell.

19. The plasma display panel of claim 1, wherein barrier ribs are formed on spaces of the second substrate corresponding to the dielectric walls and further comprising phosphor layers formed in spaces inside the barrier ribs.

20. The plasma display panel of claim 1, further comprising protective layers formed on a surface of the dielectric walls.
